(19) United States
(12) Patent Application Publication
(10) Pub. No.: US 2002/0124972 A1
(43) Pub. Date: Sep. 12, 2002

(54) GUIDANCE DEVICE FOR A FLEXIBLE CURTAIN DOOR

(76) Inventor: Bernard Simon, Caluire Et Cuire (FR)

Correspondence Address: GREENBLUM & BERNSTEIN, P.L.C., 1941 ROLAND CLARKE PLACE, RESTON, VA, 20191, US

(21) Appl. No.: 09/765,586

(22) Filed: Jan. 22, 2001

Related U.S. Application Data
(63) Continuation of application No. 09/402,487, filed on Oct. 14, 1999, now Pat. No. 6,192,960.
Application No. 09/402,487 is a 371 of international application No. PCT/FR98/00763, filed on Apr. 16, 1998.

(30) Foreign Application Priority Data
Apr. 23, 1997 (FR) 97/05305

(51) Int. Cl. E06B 3/48

(52) U.S. Cl. 160/84.06

(57) ABSTRACT

Guidance device for guiding a flexible curtain in an opening, the guidance device including a first guideway for mounting to a jam of the opening. The first guideway includes at least two straps defining a space therebetween, at least one of the two straps being stretched between at least two points on the jam. A second guideway is mounted to another jam of the opening, the second guideway comprising at least two straps defining a space therebetween. At least one of the two straps being stretched between at least two points on the jam, wherein the first and second guideways are adapted to flexibly guide the flexible curtain within the opening.—

This invention relates to a guidance device for a flexible curtain containing horizontal cross-pieces forming the panel of a motor-driven flexible curtain door, allowing the panel to be moved quickly between a closed position and an open position.

The guidance device in this invention is intended in particular for doors in which the flexible curtain is either rolled around a drum or folded, concertina-style, in a given space.

There are known flexible curtain doors which have two vertical, parallel metal supports in a U or C shape which can be fitted either directly into a concrete frame on which the door is fitted, or via elastic components placed between the vertical jambs of the concrete frame and the metal supports, as described in European patent application No. 92 909384.

Each metal support receives a straight guidance path in which the lateral edges of the flexible curtain run when it is moved between a closed position and an open position.

The guidance paths are made from channel in which a slideway is placed to guide the lateral edges of the curtain in each direction. Each guidance path includes a slideway whose internal profile is roughly square, with one edge having a slot running the full height of the said guidance path for the curtain to pass along.

The guidance paths are made of a semi-elastic material, so that when a pulling force is exerted on the curtain, the lateral edges of the curtain are released from the guidance paths.

This type of flexible curtain door has certain problems in that it is impossible to have access to and to clean the internal walls of the slideways fitted in each guidance path. When these doors are installed in rooms where food products are processed, it is essential to clean the door, and in particular the guidance paths completely after each day's work. The structure of the guidance paths described above means that this procedure is impossible without completely dismantling the door.

In addition, the guidance paths have very low resistance to impact, since the semi-elastic material of which the section is made is weakened by the slot made along its full height.

Slideways are more traditionally made of an open, U-shaped section the width across which is identical from top to bottom, a solution which is unsuitable for the way in which these doors operate.

Thus for concertina-style flexible curtain doors, these slideways have made it necessary to accommodate, when the door is open, a significant volume of stacked slats, while the passage that is necessary and sufficient in the closed position is limited to the thickness of the door.

Similarly, for roll-up doors, the curtain shifts in its vertical plane because of the change in the diameter of the roller curtain, depending on whether it is in the open or closed position. It is therefore recommended that the upper part of the slideway should be wider, to allow the panel to drop without restriction and without friction.

The guidance device in this invention is intended to correct these problems.

The guidance device in the invention comprises, on the vertical and opposite jambs of a flexible curtain door, straps which are arranged opposite each other to form a guideway on each jamb for the horizontal cross-pieces, with the said straps each being stretched and fixed between two end points built into the corresponding jamb to allow each strap, when subjected to an external force, to deform elastically and return undamaged to its original position.

The guidance device in this invention has on each jamb of the door two straps with a sloping part to provide accommodation space for the flexible curtain, and a straight vertical part so that the straps are parallel with each other to guide the said curtain in its vertical movements between a closed position and an open position.

The guidance device in this invention consists in the fact that each strap has, between a holding pin and a stop, a sloping part to form, with the other strap, a V-shaped space to accommodate the unwinding of the flexible curtain of a roll-up door when it is blocked in its descent by an obstacle.

In the invention, the guidance device consists in the fact that each strap has, between a holding pin and a stop, a first sloping part, and between the stop and another midway stop a second sloping part to form, with the other strap, a graduated opening space to accommodate the folds of the flexible curtain of a concertina-style door, when it is closed.

In this invention, the guidance device has straps the width of each of which is dependent on that of the flexible curtain of the door.

In the invention, the guidance device has stops against which the straps bear so that the line of each strap is defined along its whole length.

In this invention, the guidance device has, between two straps on a jamb of the door, and especially in the straight vertical part of these, a distance d close to that of the thickness of the flexible curtain.

In this invention, the guidance device has straps, each of which is able, when subjected to an external force, to deform elastically, on the one hand around its vertical axis, and on the other perpendicularly to its vertical axis, and to return undamaged to its original position.

This invention also relates to a flexible curtain door that comprises vertical and opposite jambs on which are fixed straps which are arranged opposite each other to form a guideway on each jamb for the horizontal cross-pieces of the flexible curtain, with the said straps each being stretched and fixed between two end points, built into the jambs to allow each strap, when subjected to an external force, to deform elastically and return undamaged to its original position.

The following description, referring to the attached drawings which are given as non-restrictive examples, will enable a better understanding of the invention, its characteristics and the advantages it can provide.

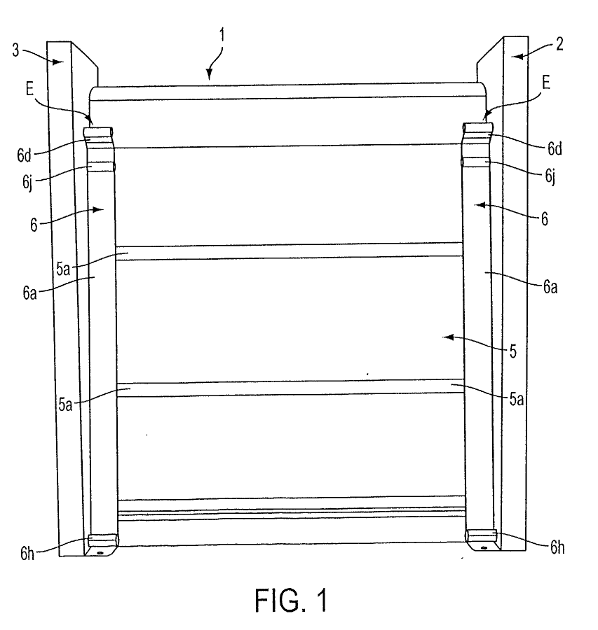

FIG. 1 is a front view showing a flexible roll-up curtain door according to this invention.

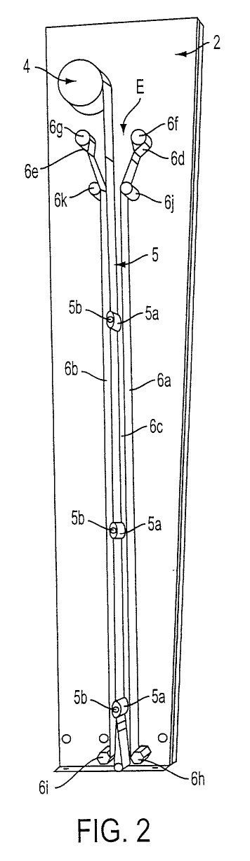

FIG. 2 is a perspective view showing a vertical jamb of the door in FIG. 1, fitted with the guidance device according to this invention.

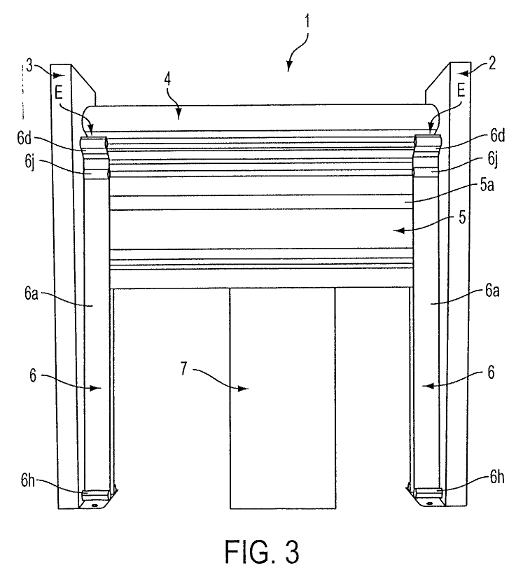

FIG. 3 is a view similar to that of FIG. 1, but showing the flexible curtain of the door hindered in its movements by an obstacle.

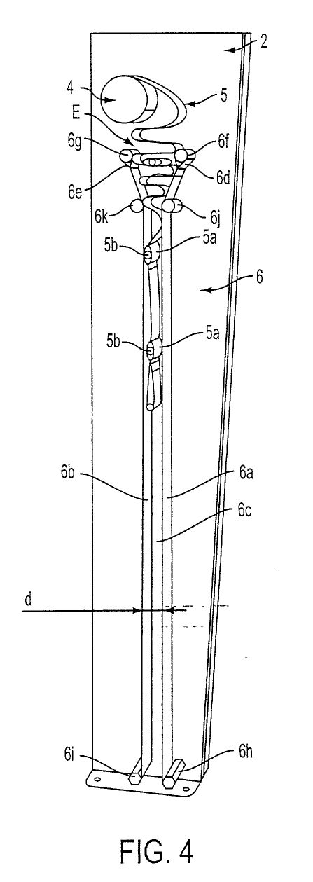

FIG. 4 is a view similar to that of FIG. 2, but showing the unwinding of the flexible curtain at the upper end of the guidance device according to the invention, when the said curtain is blocked in its descent by an obstacle.

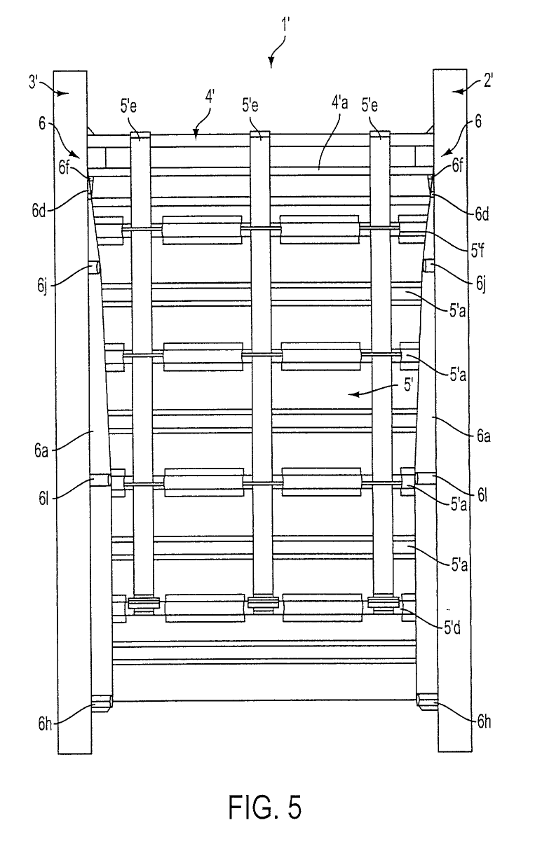

FIG. 5 is a front view showing a flexible concertina-style curtain door, according to this invention, in the closed position.

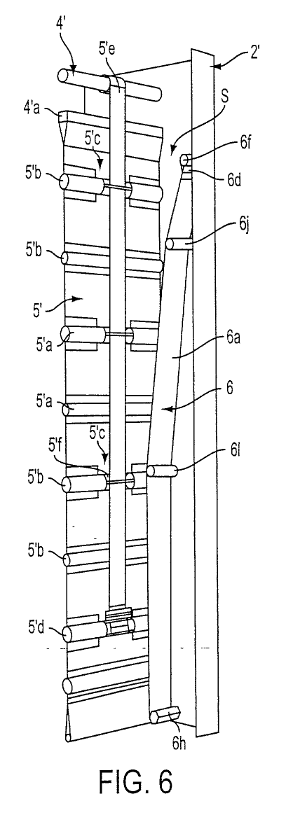

FIG. 6 is a perspective view showing a jamb of the door in FIG. 5, fitted with the guidance device according to the invention in the closed position.

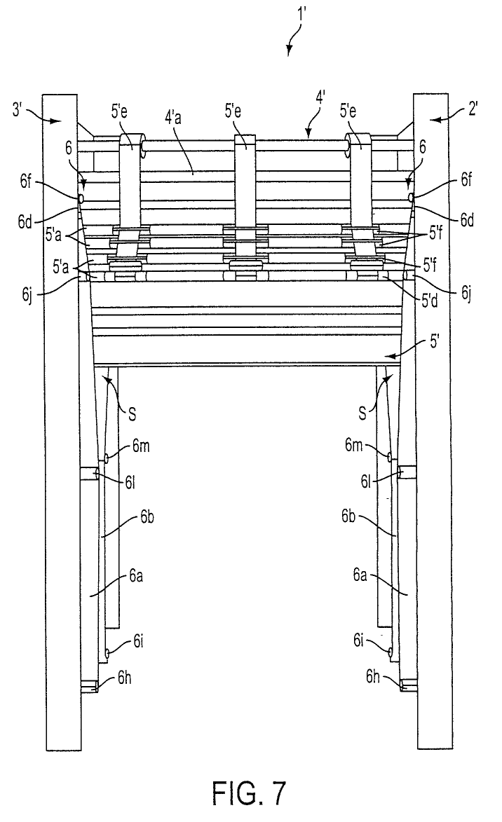

FIG. 7 is a front view showing the door in FIG. 5 in the open position.

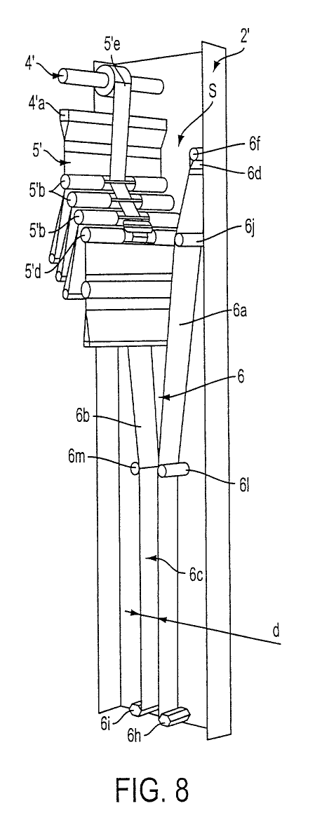

FIG. 8 is a perspective view showing one of the jambs of the door in FIG. 7, fitted with the guidance device according to the invention in the open position.

FIGS. 1 and 2 show a door 1 comprising two lateral jambs 2 and 3 which are normally fixed against the vertical walls of an opening to be closed off. The opposite and vertical jambs 2 and 3 are linked together at the top by a roller drum 4 for a flexible curtain 5.

The jambs 2 and 3 have an integral guidance device 6 for the flexible curtain 5 for its movements between a closed position and an open position.

It will be observed that the flexible curtain has sleeves 5a in which the horizontal reinforcing cross-pieces 5b are inserted, their ends engaging in the guidance devices 6 fitted on each jamb 2 and 3 (FIG. 2).

Each guidance device 6 has two straps 6a and 6b fitted one opposite the other to provide on each jamb 2 and 3 a guideway 6c for the curtain 5 and its cross-pieces 5b.

For the sake of clarity and understanding, only the guidance device 6 on jamb 2 will be described, since the other fitted on jamb 3 is identical.

The straps 6a and 6b of the guidance device 6 each have at one end a loop 6d, 6e each of which fits onto an end point formed by a holding pin 6f, 6g built into the jamb 2. Holding pins 6f and 6g are arranged one opposite the other and close to the drum 4 holding the curtain 5 of the door 1.

At the bottom of jamb 2 there are two tensioners 6h and 6i forming the other ends of the guidance device which respectively hold the opposite ends to the ends with the loops 6f and 6g of the straps 6a and 6b. The tensioners 6h and 6i are both placed at the same level, and show, for example, a six-sided outside profile so that a spanner can be used to stretch each strap 6a and 6b between the two end points formed by the pins 6f, 6g and the tensioners 6h, 6i.

There are two opposite stops 6j and 6k between the two end points of the guidance device 6, against which the straps 6a and 6b, respectively, bear.

Stops 6j and 6k are arranged on the one hand, offset with respect to pins 6f and 6g and on the other, on the same vertical axis as the tensioners 6h and 6i. This configuration allows the straps 6a and 6b to include a sloping part to provide accommodation space E for the flexible curtain 5 near the drum 4, whose function will be seen later

Straps 6a and 6b have, in the extension of the accommodation space E a straight vertical part so that the said straps are parallel with each other to guide the flexible curtain 5 in its vertical movements between a closed position and an open position.

Thus each strap 6a and 6b has a sloping part between the respective pins 6f, 6g and the stops 6d, 6k to form space E which is more particularly V-shaped.

FIGS. 3 and 4 show the flexible curtain 5 of the roll-up door 1 which is blocked in its descent by an obstacle 7. Under these conditions the curtain 5 continues to unwind and is accommodated in space E of the guidance device 6. It is then only necessary to reverse the rotation of the drum 4 to roll the curtain 5 up again.

FIGS. 5 and 8 show a concertina-style door 1′ with two lateral jambs 2′ and 3′ which are fixed against the vertical walls of an opening to be closed off.

The opposite and vertical jambs 2′ and 3′ are linked together at the top of the door 1′ by a winding drum 4′ and a transverse fixed bar 4′a on which is held a flexible curtain 5′.

Jambs 2′ and 3′ are integral with a guidance device 6 similar to that described above for the rollup door 1. The guidance device 6 has a slideway 6c for guiding the flexible curtain 5′ when it moves between a closed position and an open position.

The flexible curtain 5′ has sleeves 5′a with openings 5′c for passage of horizontal reinforcing cross-pieces 5′b. The flexible curtain 5′ has another horizontal cross-piece 5′d at the bottom which is linked by pulling straps 5′e to the winding drum 4′ The straps 5′e are guided at each horizontal reinforcing cross-piece 5′b via strap carriers 5′f arranged in the openings 5′c of the sleeves 5′a. Sleeves 5′a without openings are also provided, in which other reinforcing cross-pieces 5′b are inserted.

The drive system for the curtain 5′ described above allows it to fold up, as it is opened in the upper pare of the door 1′.

For the sake of clarity and understanding, only V, the guidance device 6 on jamb 2′ will be described, since the other fitted on jamb 3′ is identical. Moreover it is mainly the new and additional parts of the guidance device 6 not used in the roll-up door 1 which will be described here.

Thus the straps 6a and 6b with their loops 6b and 6c are fixed and stretched between two end points built into the jamb 2′, that is between the pins 6f, 6g and the tensioners 6h, 6i.

Each strap 6a and 6b is supported between the pins 6f, 6g and the tensioners 6h, 6i on a first upper stop 6j, 6k and on a second midway stop 6l, 6m.

The straps 6a, 6b include between pins 6f, 6g and stops 6j, 6k an initial slope which is extended by a second slope at a different angle between stops 6j, 6k and midway stops 6l, 6m.

This configuration allows the straps 6a and 6b to mark out a graduated opening space S to take the folds of the flexible curtain 5′ as it opens (FIGS. 7 and 8).

The straps 6a and 6b have, in the extension of the space S, a straight vertical part so that the said straps are parallel with each other to guide the flexible curtain 5′ in its movements.

It will be noted that the guidance devices 6 built into the jambs 2, 2′ and 3, 3′ of the doors 1, 1′ are accessible without being dismantled and are easy to clean when the doors are intended for use in a food handling environment.

In addition, the guidance devices 6 fitted on the doors 1 and 1′ have straps 6a and 6b whose width depends on that of curtain 5, 5′ to be moved.

The guidance devices 6 have, between two straps 6a, 6b on one jamb of the door, and especially in the straight vertical part of these, a distance d close to that of the thickness of the flexible curtain 5, 5′.

It will be observed that the guidance devices 6 have straps 6a, 6b, each of which is able, when subjected to external force, to deform elastically, on the one hand around its vertical axis and on the other perpendicularly to its vertical axis, and to return undamaged to its original position.

This is because the relative elastic deformation of the straps 6a, 6b when the flexible curtain 5, 5′ is blocked, or a lateral impact occurs, allows the horizontal cross-pieces to move out of position without risk of damage to the cross-pieces or to the straps.

In addition, the guidance device 6 reduces operating noise since there is no metal-to-metal contact, such as occurs on other doors.

1. Guidance device for a flexible curtain (5, 5′) containing horizontal cross-pieces (5b, 5′b, 5′d ) to form the panel of a door (1, 1′ ), characterized in that it comprises, on the vertical and opposite jambs (2, 3; 2′, 3′) of the door (1, 1′), straps (6a, 6b ) which are arranged opposite each other to form a guideway (6c ) on each jamb for the flexible curtain (5, 5′) and horizontal cross-pieces (5b, 5′b, 5′d ), with the said straps each being stretched and fixed between two end points (6f, 6h ; 69, 6i ) built into the jambs (2, 3; 2′, 3′) to allow each strap, when subjected to an external force, to deform elastically and return undamaged to its original position.

2. Guidance device according to claim 1, characterized in that it has on each jamb (2, 3; 2′, 3) of the door (1, 1′) two straps (6a, 6b ) with a sloping part to provide accommodation space (E, S) for the flexible curtain (5, 5′) and a straight vertical part so that the straps (6a, 6b ) are parallel with each other to guide the said curtain in its vertical movements between a closed position and an open position.

3. Guidance device according to claim 2, characterized in that each strap (6a, 6b ) has, between a holding pin (6f, 6g ) and a stop (6j, 6k ), a sloping part to form, with the other strap, a V-shaped space (E) to accommodate the unwinding of the flexible curtain (5) of a roll-up door (1) when it is blocked in its descent by an obstacle (7).

4. Guidance device according to claim 2, characterized in that each strap (6a, 6b ) has, between a holding pin (6f, 6g ) and a stop (6j, 6k ), a first sloping part, and between the stop (6j, 6k ) and another midway stop (6l, 6m ) a second sloping part to form, with the other strap, a graduated opening space (S) to accommodate the folds of the flexible curtain (5′) of a concertina-style door (1′), when it is closed.

5. Guidance device according to claim 1, characterized in that the straps (6a, 6b ) have a width dependent on that of the flexible curtain (5, 5′) of the door (1, 1′).

6. Guidance device according to claim 1, characterized in that it has stops (6j, 6k, 6l, 6m ) against which the straps (6a, 6b ) bear.

7. Guidance device according to claim 2, characterized in that it has, between two straps (6a ) and (6b ), and especially in the straight vertical part of these, a distance (d) close to that of the thickness of the flexible curtain (5, 5′).

8. Guidance device according to claim 1, characterized in that it has straps (6a, 6b ) , each of which is able, when subjected to an external force, to deform elastically on the one hand around its vertical axis and on the other perpendicularly to its vertical axis, and to return undamaged to its original position.

9. Flexible curtain door, characterized in that it comprises vertical and opposite jambs (2, 3;, 2′, 3′) on which are fixed straps (6a, 6b ) which are arranged opposite each other to form a guideway (6c ) on each jamb for the horizontal cross-pieces (5b, 5′b, 5′d ) and flexible curtains (5, 5′), with the said straps each being stretched and fixed between two end points (6j [sic], 6h ; 69, 6i ) built into the jambs to allow each strap, when subjected to an external force, to deform elastically and return undamaged to its original position.
